(19) United States
(12) Patent Application Publication
(10) Pub. No.: US 2022/0139071 A1
(43) Pub. Date: May 5, 2022

(54) INFORMATION PROCESSING DEVICE, INFORMATION PROCESSING METHOD, INFORMATION PROCESSING PROGRAM, AND INFORMATION PROCESSING SYSTEM

(71) Applicant: SONY SEMICONDUCTOR SOLUTIONS CORPORATION, KANAGAWA (JP)

(72) Inventor: YUJI HANDA, KANAGAWA (JP)

(21) Appl. No.: 17/437,573

(22) PCT Filed: Mar. 18, 2020
(86) PCT No.: PCT/JP2020/012014

§ 371 Date: Sep. 9, 2021

(30) Foreign Application Priority Data
Mar. 25, 2019 (JP) 2019-057360

(51) Int. Cl. G06V 10/77; G06V 20/58; G06N 3/04; G06V 10/82

(52) U.S. Cl. CPC G06V 10/7715; G06V 10/82; G06N 3/0454; G06V 20/58

(57) ABSTRACT

An information processing device (1) according to the present disclosure includes a first processing unit (2) and a second processing unit (3). The first processing unit (2) includes a first feature amount extraction unit (22) and a second feature amount extraction unit (23). The first feature amount extraction unit (22) executes, on data input from a sensor, feature amount extraction processing of extracting a feature amount of the data on the basis of a parameter learned through machine learning. The second feature amount extraction unit (23) executes, on reference data, feature amount extraction processing of extracting a feature amount of the reference data on the basis of the parameter. The second processing unit (3) includes a difference detection unit (33). The difference detection unit (33) detects a difference between a first feature amount input from the first feature amount extraction unit (22) and a second feature amount input from the second feature amount extraction unit (23).

### TECHNICAL FIELD

The present disclosure relates to an information processing device, an information processing method, an information processing program, and an information processing system.

### BACKGROUND ART

There are information processing devices which perform image recognition processing using a processor such as a CPU (Central Processing Unit) (see, for example, PTL 1).

### CITATION LIST

### Patent Literature

[PTL 1]

JP 2004-199148A

### SUMMARY

### Technical Problem

However, when, for example, an information processing device recognizes multiple types of objects using a learning model that applies parameters obtained by machine learning, the amount of training data required to obtain appropriate parameters becomes enormous.

Accordingly, the present disclosure proposes an information processing device, an information processing method, an information processing program, and an information processing system capable of recognizing multiple types of objects even when the amount of training data used for machine learning is reduced.

### Solution to Problem

An information processing device according to the present disclosure includes a first processing unit and a second processing unit. The first processing unit includes a first feature amount extraction unit and a second feature amount extraction unit. The first feature amount extraction unit executes, on data input from a sensor, feature amount extraction processing of extracting a feature amount of the data on the basis of a parameter learned through machine learning. The second feature amount extraction unit executes, on reference data, feature amount extraction processing of extracting a feature amount of the reference data on the basis of the parameter. The second processing unit includes a difference detection unit. The difference detection unit detects a difference between a first feature amount input from the first feature amount extraction unit and a second feature amount input from the second feature amount extraction unit.

### BRIEF DESCRIPTION OF DRAWINGS

FIG. 1 is a descriptive diagram illustrating machine learning according to the present disclosure.

FIG. 2 is a block diagram illustrating an example of the configuration of an information processing system according to the present disclosure.

FIG. 3 is a flowchart illustrating an example of processing executed by an information processing device according to the present disclosure.

### DESCRIPTION OF EMBODIMENTS

Hereinafter, an embodiment of the present disclosure will be described in detail with reference to the drawings. In the following embodiment, the same parts are denoted by the same reference numerals and thus duplicate description will be omitted.

(1. Machine Learning Performed by Information Processing Device)

An information processing device 1 according to the present disclosure recognizes and judges objects from an image using a recognizer that is machine-trained through one-shot learning using a Siamese Network.

The following will describe a case where the information processing device according to the present disclosure is installed in a vehicle and is a device that judges whether an object in an image captured by an in-vehicle camera is a vehicle or a non-vehicle, or a motorcycle or a non-motorcycle. However, the judgment target of the information processing device according to the present disclosure is not limited to vehicles and motorcycles, and may be any object that can be judged from an image, such as a pedestrian, an obstacle, and the like.

Computational graphs (functions) used in machine learning are generally called models, which are multi-level structures modeled after human brain neural circuits (neural networks) designed through machine learning to recognize object features (patterns) from image data.

The model can be separated at any layer by aligning the format of output data (the number of dimensions of a multidimensional vector, the size of each dimension, and the number of all elements) of the nodes connected to the previous stage of a plurality of nodes located at each layer with the format of the input data of nodes connected to the following stage of those nodes.

With respect to the parameters, different parameters can be input and used even for models having the same structure. A model will behave differently as a recognizer when the input parameters are different. For example, when the input parameters are changed, a model will be able to recognize different objects compared to before the parameters were changed. Such parameters are acquired by machine learning.

Additionally, in a model, layers close to the input (shallow layers) mainly extract feature amounts of the input data. Such layers that are close to the input use many sum-of-products operations to determine data correlation. In particular, when the input data is image data, the layers close to the input are subjected to multidimensional sum-of-products operations, resulting in a high processing load. On the other hand, layers close to the output perform processing according to the task, such as classification and regression of the recognition target, but generally use data with reduced dimensions, resulting in a lower processing load than that of the layers close to the input.

Here, when, for example, an information processing device recognizes multiple types of objects using a model that applies parameters obtained by machine learning, the amount of training data required to obtain appropriate parameters becomes enormous.

For example, when the information processing device determines whether an object in an image captured by a camera is a vehicle or a non-vehicle, whether the object in the captured image is a vehicle or a non-vehicle can be determined if input image data is similar to image data of a vehicle that has been learned in advance through machine learning.

However, the information processing device cannot determine whether an object in a captured image is a vehicle or a non-vehicle if the input image data is significantly different from image data of a vehicle that has been learned in advance through machine learning. It is therefore necessary for the information processing device to learn, through machine learning, the image data of a large number of vehicles captured from various angles and distances in advance.

Furthermore, when the information processing device judges multiple objects other than vehicles in addition to vehicles, it is necessary to perform machine learning in advance for image data of objects captured from various angles and distances for each type of object in addition to the image data of vehicles, which results in a huge amount of training data.

Accordingly, by using a recognizer that has undergone machine learning through one-shot learning using a Siamese network, the information processing device according to the present disclosure can recognize multiple types of objects with even a small amount of training data.

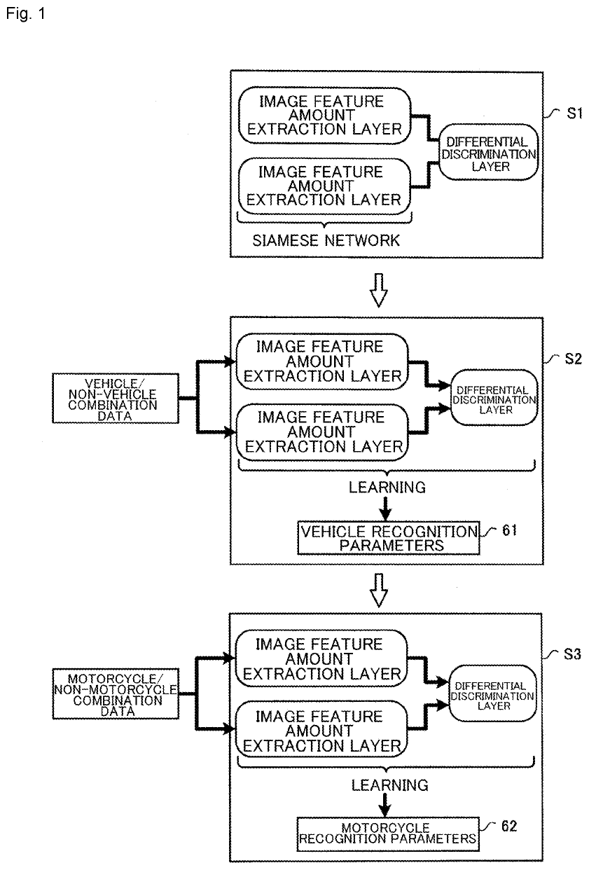

FIG. 1 is a descriptive diagram illustrating machine learning according to the present disclosure. As illustrated in FIG. 1, in the present disclosure, a Siamese network model is first constructed by placing two general image feature amount extraction layers in parallel in a first stage, and connecting those layers to a differential discrimination layer placed in the next stage (step S1). The two image feature amount extraction layers have the same structure, and as a default are input (also called “loaded” hereinafter) with the same general parameters for extracting feature amounts of input data.

The image feature amount extraction layer is a model that extracts feature amounts of the input image data and outputs multidimensional vectors indicating the extracted feature amounts to the differential discrimination layer. The differential discrimination layer is a model that detects differences in feature amounts by calculating a distance between the multidimensional vectors input from the two image feature amount extraction layers.

Next, in the present disclosure, the two image feature amount extraction layers are trained by inputting combination data of vehicles and non-vehicles (step S2). For example, in the present disclosure, image data of an image of a vehicle is first input into one of the image feature amount extraction layers and image data of an image of an object other than a vehicle (such as a person or a landscape) is input into the other image feature amount extraction layer, and the differential layer is then caused to detect differences in the feature amounts between the two images.

Next, in the present disclosure, image data of an image of an object other than a vehicle (such as a person or a landscape) is input into the one image feature amount extraction layer and image data of an image of a vehicle is input into the other image feature amount extraction layer, and the differential layer is then caused to detect differences in the feature amounts between the two images.

Next, in the present disclosure, image data of an image of a vehicle is input into the two image feature amount extraction layers, and the differential layer is then caused to detect differences in the feature amounts between the two images. The image data input into the two image feature amount extraction layers may be image data in which the size, model, and orientation of the vehicle are different, as long as the images are images of vehicles.

As a result, the parameters of the image feature amount extraction layers are adjusted through training which reduces differences between the detected feature amounts when image data of an image of a vehicle is input to the two image feature amount extraction layers, and increases differences in other cases. As a result, vehicle recognition parameters 61, which are suited to judging whether an object in an image is a vehicle or not and which are shared by the two image feature amount extraction layers, are obtained.

Furthermore, in the present disclosure, the two image feature amount extraction layers are trained by inputting combination data of motorcycles and non-motorcycles (step S3). For example, in the present disclosure, image data of an image of a motorcycle is first input into one of the image feature amount extraction layers and image data of an image of an object other than a motorcycle (such as a person or a vehicle) is input into the other image feature amount extraction layer, and the differential layer is then caused to detect differences in the feature amounts between the two images.

Next, in the present disclosure, image data of an image of an object other than a motorcycle (such as a person or a vehicle) is input into the one image feature amount extraction layer and image data of an image of a motorcycle is input into the other image feature amount extraction layer, and the differential layer is then caused to detect differences in the feature amounts between the two images.

Next, in the present disclosure, image data of an image of a motorcycle is input into the two image feature amount extraction layers, and the differential layer is then caused to detect differences in the feature amounts between the two images. The image data input into the two image feature amount extraction layers may be image data in which the size, model, and orientation of the motorcycle are different, as long as the images are images of motorcycles.

As a result, the parameters of the image feature amount extraction layers are adjusted through training which reduces differences between the detected feature amounts when image data of an image of a motorcycle is input to the two image feature amount extraction layers, and increases differences in other cases. As a result, motorcycle recognition parameters 62, which are suited to judging whether an object in an image is a motorcycle or not and which are shared by the two image feature amount extraction layers, are obtained.

Then, in the present disclosure, two image feature amount extraction layers having the same structure, which have higher processing loads than the differential discrimination layer, are implemented in the information processing device as hardware logic in an FPGA (Field Programmable Gate Array). Then, in the present disclosure, the vehicle recognition parameters 61 or the motorcycle recognition parameters 62 are selected according to the judgment target and loaded into the image feature amount extraction layer through software control.

In the present disclosure, a differential discrimination unit is implemented in the information processing device as software executed by a CPU (Central Processing Unit) by using the differential discrimination layer, which has a lower processing load than the image feature amount extraction layers.

As a result, the information processing device according to the present disclosure does not need to store software for the image feature amount extraction layers, which have a relatively large amount of data, and can therefore reduce the amount of data in the stored software. Furthermore, in the present disclosure, a model that judges using two feature amount vectors extracted in the two image feature amount extraction layers may be applied and trained as well. In this case, parameters for differential discrimination are used in addition to the differential discrimination layer.

(2. Example of Configuration of Information Processing System)

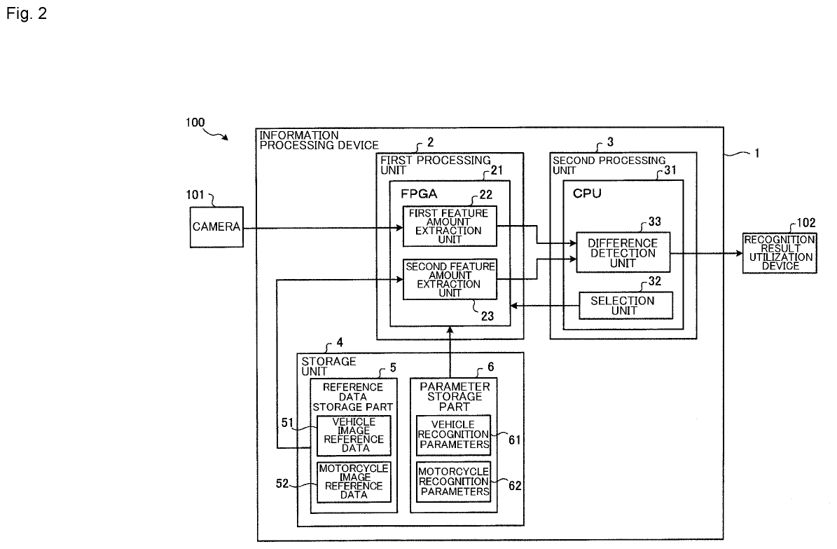

An example of the configuration of the information processing system according to the present disclosure will be described next with reference to FIG. 2. FIG. 2 is a block diagram illustrating an example of the configuration of an information processing system 100 according to the present disclosure. As illustrated in FIG. 2, the information processing system 100 includes the information processing device 1, a camera 101, and a recognition result utilization device 102. The information processing device 1 is connected to the camera 101 and the recognition result utilization device 102.

The camera 101, for example, captures an image of the surroundings of a vehicle in which the information processing device 1 is installed, and outputs image data of the captured image to the information processing device 1. The recognition result utilization device 102 uses a result of judging vehicles and motorcycles by the information processing device 1 to, for example, control an automatic emergency braking system, an autonomous driving system, or the like of the vehicle in which the information processing device 1 is installed.

The information processing device 1 includes a first processing unit 2, a second processing unit 3, and a storage unit 4. The storage unit 4 is an information storage device such as, for example, flash memory, and includes a reference data storage part 5 and a parameter storage part 6.

The reference data storage part 5 stores vehicle image reference data 51 and motorcycle image reference data 52. The vehicle image reference data 51 is image data of captured images of vehicles, prepared in advance. The motorcycle image reference data 52 is image data of captured images of motorcycles, prepared in advance.

The parameter storage part 6 stores the vehicle recognition parameters 61 and the motorcycle recognition parameters 62. The vehicle recognition parameters 61 are parameters obtained through machine learning as described above, and are parameters for an image feature amount extraction layer suited to determining whether or not an object in an image is a vehicle. The motorcycle recognition parameters 62 are parameters obtained through machine learning as described above, and are parameters for an image feature amount extraction layer suited to determining whether or not an object in an image is a motorcycle.

The first processing unit 2 includes an FPGA 21. The FPGA 21 includes a first feature amount extraction unit 22 and a second feature amount extraction unit 23, both of which are provided with an image feature amount extraction layer having the same structure as described above.

When determining whether an object in image data is a vehicle or a non-vehicle, the information processing device 1 loads the vehicle recognition parameters 61 into the first feature amount extraction unit 22 and the second feature amount extraction unit 23, and inputs the vehicle image reference data 51 into the second feature amount extraction unit 23.

Additionally, when determining whether an object in image data is a motorcycle or a non-motorcycle, the information processing device 1 loads the motorcycle recognition parameters 62 into the first feature amount extraction unit 22 and the second feature amount extraction unit 23, and inputs the motorcycle image reference data 52 into the second feature amount extraction unit 23.

The first feature amount extraction unit 22 extracts a feature amount from the image data input from the camera 101, and outputs the feature amount as a first feature amount to the second processing unit 3. The second feature amount extraction unit 23 extracts a feature amount from the input vehicle image reference data 51 or motorcycle image reference data 52, and outputs the feature amount as a second feature amount to the second processing unit 3.

The second processing unit 3 includes a CPU 31. The CPU 31 includes a selection unit 32 that functions by executing a predetermined selection program. The selection unit 32 selects the parameters to be applied to the first feature amount extraction unit 22 and the second feature amount extraction unit 23, and the reference data to be input to the second feature amount extraction unit 23, in accordance with the type of the object for which image recognition is required.

For example, when the object for which image recognition is required is a vehicle, the selection unit 32 causes the FPGA 21 to load the vehicle recognition parameters 61 into the first feature amount extraction unit 22 and the second feature amount extraction unit 23, and to load the vehicle image reference data 51 into the second feature amount extraction unit 23.

Additionally, when the object for which image recognition is required is a motorcycle, the selection unit 32 causes the FPGA 21 to load the motorcycle recognition parameters 62 into the first feature amount extraction unit 22 and the second feature amount extraction unit 23, and to load the motorcycle image reference data 52 into the second feature amount extraction unit 23.

Additionally, the CPU 31 includes a difference detection unit 33 that functions by executing a differential discrimination program as described above. The difference detection unit 33 detects a difference between the first feature amount input from the first feature amount extraction unit 22 and the second feature amount input from the second feature amount extraction unit 23, and outputs a differential discrimination result, which serves as an image recognition result based on the difference, to the recognition result utilization device 102.

For example, when the difference between the first feature amount extracted from the image data of the captured image and the second feature amount extracted from the vehicle image reference data 51 is less than a predetermined threshold, the difference detection unit 33 outputs a differential discrimination result indicating that the object in the captured image is a vehicle.

Additionally, when the difference between the first feature amount extracted from the image data of the captured image and the second feature amount extracted from the vehicle image reference data 51 is greater than or equal to the predetermined threshold, the difference detection unit 33 outputs a differential discrimination result indicating that the object in the captured image is not a vehicle.

Additionally, when the difference between the first feature amount extracted from the image data of the captured image and the second feature amount extracted from the motorcycle image reference data 52 is less than a predetermined threshold, the difference detection unit 33 outputs a differential discrimination result indicating that the object in the captured image is a motorcycle.

Additionally, when the difference between the first feature amount extracted from the image data of the captured image and the second feature amount extracted from the motorcycle image reference data 52 is greater than or equal to the predetermined threshold, the difference detection unit 33 outputs a differential discrimination result indicating that the object in the captured image is not a motorcycle.

In this manner, the information processing device 1 judges whether an object in a captured image is a vehicle or a non-vehicle, or a motorcycle or a non-motorcycle, on the basis of feature amounts in the image data of the captured image and the similarity (resemblance) to the vehicle image reference data 51 or the motorcycle image reference data 52.

Accordingly, the information processing device 1 can, for example, judge whether an object in a captured image is a vehicle or a non-vehicle on the basis of the feature amounts in the image data and the feature amounts in the vehicle image reference data 51, even without performing machine learning in advance using image data resembling the image data of the captured image.

Likewise, the information processing device 1 can, for example, judge whether an object in a captured image is a motorcycle or a non-motorcycle on the basis of the feature amounts in the image data and the feature amounts in the motorcycle image reference data 52, even without performing machine learning in advance using image data resembling the image data of the captured image. Accordingly, the information processing device 1 can recognize and judge multiple types of objects even when the amount of training data used in the advance machine learning is small.

Additionally, the information processing device 1 can judge multiple types of objects simply by changing the parameters loaded into the first feature amount extraction unit 22 and the second feature amount extraction unit 23 and changing the reference data input into the second feature amount extraction unit 23 using the selection unit 32.

Note that the selection unit 32 can, for example, select the parameters loaded into the first feature amount extraction unit 22 and the second feature amount extraction unit 23, and the reference data input into the second feature amount extraction unit 23, in response to a setting operation made by a driver of a vehicle, for example.

Alternatively, for example, the selection unit 32 can automatically change the parameters loaded into the first feature amount extraction unit 22 and the second feature amount extraction unit 23, and the reference data input into the second feature amount extraction unit 23.

In this case, for example, the selection unit 32 changes the parameters loaded into the first feature amount extraction unit 22 and the second feature amount extraction unit 23, and the reference data input into the second feature amount extraction unit 23, for each frame of the image captured by the camera 101. Through this, the information processing device 1 can judge whether an object is a vehicle or a non-vehicle, or a motorcycle or a non-motorcycle, as long as at least one frame of an image has been captured.

Additionally, the information processing device 1 can judge the model of the vehicle, the motorcycle, or the like by storing image reference data for each model in the reference data storage part 5, for example. Although the camera 101 is described here as an example of a sensor that inputs data into the information processing device 1, the sensor that inputs data into the information processing device 1 may be any sensor capable of learning parameters that enable accurate judgment, such as, for example, millimeter wave radar, LIDAR (Light Detection and Ranging), an ultrasonic sensor, or the like.

For example, when the information processing device 1 judges whether an object detected by millimeter wave radar is a vehicle or a non-vehicle, a feature amount extraction layer that extracts a feature amount from millimeter wave data detected by the millimeter wave radar is implemented in the FPGA 21 as hardware.

Then, the information processing device 1 performs machine learning in advance using the millimeter wave data detected by the millimeter wave radar at locations where there are vehicles and locations where there are no vehicles, obtains parameters of the feature amount extraction layer for the millimeter wave data, and stores the parameters in the parameter storage part 6. Furthermore, the information processing device 1 stores the millimeter wave data detected by the millimeter wave radar at locations where there are vehicles in the reference data storage part 5.

As a result, the information processing device 1 can determine whether the object detected by the millimeter wave radar is a vehicle or a non-vehicle by obtaining the feature amounts of the data actually detected by the millimeter wave sensor and the feature amounts of the reference data of the millimeter wave data, and inputting the feature amounts into the difference detection unit 33. Note that the information processing device 1 can judge a detected object on the basis of data input in the same manner even when the data is input from a different type of sensor, such as LIDAR or the like.

Additionally, although a case where the second processing unit 3 includes the CPU 31 is described as an example here, the second processing unit 3 of the information processing device 1 may include an information processing device aside from the CPU 31 as long as it is an information processing device capable of executing the same processing as that executed by the second processing unit 3 described above.

For example, instead of the CPU 31, the information processing device 1 may be configured including a different type of information processing device, such as an FPGA, a DSP (Digital Signal Processor), a GPU (Graphics Processing Unit), or the like.

(3. Processing Executed by Information Processing Device)

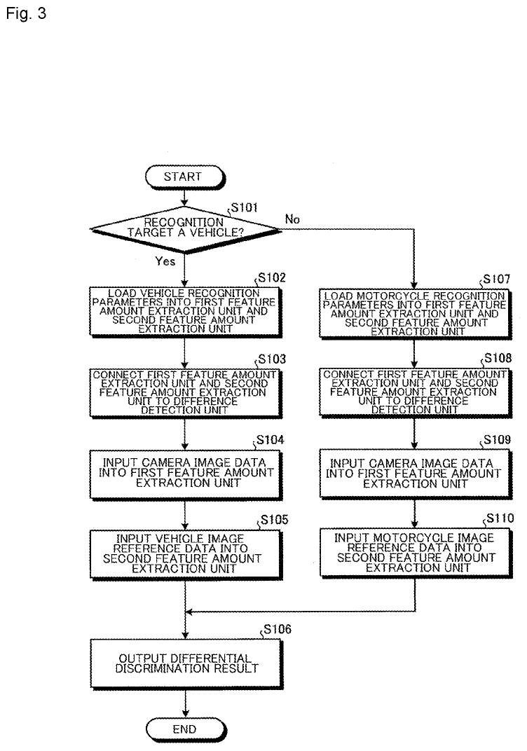

Processing executed by the information processing device 1 will be described next with reference to FIG. 3. FIG. 3 is a flowchart illustrating an example of processing executed by the information processing device 1 according to the present disclosure. The information processing device 1 repeatedly executes the processing illustrated in FIG. 3 during a period when an image is captured by the camera 101.

Specifically, as illustrated in FIG. 3, the information processing device 1 first determines whether or not the recognition target is a vehicle (step S101). Then, when the recognition target is determined to be a vehicle (step S101, Yes), the information processing device 1 loads the vehicle recognition parameters 61 into the first feature amount extraction unit 22 and the second feature amount extraction unit 23 (step S102).

Next, the information processing device 1 connects the first feature amount extraction unit 22 and the second feature amount extraction unit 23 to the difference detection unit 33 (step S103), and inputs the camera image data to the first feature amount extraction unit 22 (step S104). Then, the information processing device 1 inputs the vehicle image reference data 51 into the second feature amount extraction unit 23 (step S105), after which the processing moves to step S106.

On the other hand, when the recognition target is determined not to be a vehicle (step S101, No), the information processing device 1 loads the motorcycle recognition parameters 62 into the first feature amount extraction unit 22 and the second feature amount extraction unit 23 (step S107).

Next, the information processing device 1 connects the first feature amount extraction unit 22 and the second feature amount extraction unit 23 to the difference detection unit 33 (step S108), and inputs the camera image data to the first feature amount extraction unit 22 (step S109). Then, the information processing device 1 inputs the motorcycle image reference data 52 into the second feature amount extraction unit 23 (step S110), after which the processing moves to step S106.

In step S106, the information processing device 1 outputs the differential discrimination result to the recognition result utilization device 102, and ends the processing. The information processing device 1 then starts the processing illustrated in FIG. 3 again from step S101.

(4. Effects)

The information processing device 1 includes the first processing unit 2 and the second processing unit 3. The first processing unit 2 includes the first feature amount extraction unit 22 and the second feature amount extraction unit 23. The first feature amount extraction unit 22 executes, on data input from the camera 101 serving as an example of a sensor, feature amount extraction processing of extracting a feature amount of the data on the basis of the vehicle recognition parameters 61 or the motorcycle recognition parameters 62, which are examples of parameters learned through machine learning. The second feature amount extraction unit 23 executes, on the vehicle image reference data 51 or the motorcycle image reference data 52 serving as an example of the reference data, feature amount extraction processing of extracting a feature amount of the vehicle image reference data 51 or the motorcycle image reference data 52 on the basis of the vehicle recognition parameters 61 or the motorcycle recognition parameters 62, which are examples of the parameters. The second processing unit 3 includes the difference detection unit 33. The difference detection unit 33 detects a difference between the first feature amount input from the first feature amount extraction unit 22 and the second feature amount input from the second feature amount extraction unit 23. Through this, the information processing device 1 can recognize and judge multiple types of objects even when the amount of training data used in the advance machine learning is small.

Additionally, the first feature amount extraction unit 22 is input with image data captured by the camera 101. The second feature amount extraction unit 23 is input with the vehicle image reference data 51 or the motorcycle image reference data 52 including an image of an object for which image recognition is required. The difference detection unit 33 outputs a result of the image recognition in accordance with the difference. Through this, the information processing device 1 can judge a vehicle and a motorcycle in the captured image even with a small amount of training data.

The information processing device 1 also includes the storage unit 4 and the selection unit 32. The storage unit 4 that stores the vehicle recognition parameters 61 or the motorcycle recognition parameters 62, which are an example of a plurality of the parameters different for each of types of the object for which the image recognition is required, and the vehicle image reference data 51 or the motorcycle image reference data 52, which are an example of a plurality of the reference data different for each of the types of the object. The selection unit 32 selects the parameters to be applied to the first feature amount extraction unit and the second feature amount extraction unit, and the reference data to be input to the second feature amount extraction unit, in accordance with the type of the object for which image recognition is required. Through this, the information processing device 1 can judge multiple types of objects simply by changing the parameters loaded into the first feature amount extraction unit 22 and the second feature amount extraction unit 23 and changing the reference data input into the second feature amount extraction unit 23 using the selection unit 32.

Additionally, the first feature amount extraction unit 22 and the second feature amount extraction unit 23 include machine learning models having the same structure. Through this, the first feature amount extraction unit 22 and the second feature amount extraction unit 23 can be implemented in the information processing device 1 with ease.

Additionally, the first processing unit 2 is constituted by hardware. The second processing unit 3 is constituted by software. Through this, the information processing device 1 does not need to store software for the first feature amount extraction unit 22 and the second feature amount extraction unit 23, which have a relatively large amount of data, and can therefore reduce the amount of data in the stored software.

An information processing method executed by a computer includes a first processing step and a second processing step. The first processing step includes a first feature amount extraction step and a second feature amount extraction step. The first feature amount extraction step executes, on data input from a sensor, feature amount extraction processing of extracting a feature amount of the data on the basis of a parameter learned through machine learning. The second feature amount extraction step executes, on reference data, feature amount extraction processing of extracting a feature amount of the reference data on the basis of the parameter. The second processing step includes a difference detection step. The difference detection step executes a difference between the first feature amount extracted in the first feature amount extraction step and the second feature amount extracted in the second feature amount extraction step. Through this, the information processing program can recognize and judge multiple types of objects even when the amount of training data used in the advance machine learning is small. The information processing method can recognize and judge multiple types of objects even when the amount of training data used in the advance machine learning is small.

Additionally, an information processing program causes a computer to execute a first processing sequence and a second processing sequence. The first processing sequence includes a first feature amount extraction sequence and a second feature amount extraction sequence. The first feature amount extraction sequence executes, on data input from a sensor, feature amount extraction processing of extracting a feature amount of the data on the basis of a parameter learned through machine learning. The second feature amount extraction sequence executes, on reference data, feature amount extraction processing of extracting a feature amount of the reference data on the basis of the parameter. The second processing sequence includes a difference detection sequence. The difference detection sequence detects a difference between the first feature amount extracted in the first feature amount extraction sequence and the second feature amount extracted in the second feature amount extraction sequence. Through this, the information processing program can recognize and judge multiple types of objects even when the amount of training data used in the advance machine learning is small.

Additionally, the information processing system 100 includes the camera 101, the information processing device 1, and the recognition result utilization device 102. The information processing device 1 performs recognition processing on image data input from the camera 101. The recognition result utilization device 102 performs predetermined control using a result of the recognition processing. The information processing device 1 includes the first processing unit 2 and the second processing unit 3. The first processing unit 2 includes the first feature amount extraction unit 22 and the second feature amount extraction unit 23. The first feature amount extraction unit 22 executes, on the image data, feature amount extraction processing of extracting a feature amount of the image data on the basis of the vehicle recognition parameters 61 or the motorcycle recognition parameters 62, which are examples of parameters learned through machine learning. The second feature amount extraction unit 23 executes, on the vehicle image reference data 51 or the motorcycle image reference data 52 serving as an example of the reference data, feature amount extraction processing of extracting a feature amount of the vehicle image reference data 51 or the motorcycle image reference data 52 on the basis of the vehicle recognition parameters 61 or the motorcycle recognition parameters 62, which are examples of the parameters. The second processing unit 3 includes the difference detection unit 33. The difference detection unit 33 detects a difference between the first feature amount input from the first feature amount extraction unit 22 and the second feature amount input from the second feature amount extraction unit 23. Through this, the information processing system can recognize and judge multiple types of objects even when the amount of training data used in the advance machine learning is small.

The advantageous effects described in the present specification are merely exemplary and are not limited, and other advantageous effects may be obtained.

The present technique can also take on the following configurations.

(1)

An information processing device comprising:

a first processing unit including:

a first feature amount extraction unit that executes, on data input from a sensor, feature amount extraction processing of extracting a feature amount of the data on the basis of a parameter learned through machine learning, and

a second feature amount extraction unit that executes, on reference data, feature amount extraction processing of extracting a feature amount of the reference data on the basis of the parameter;

and

a second processing unit including:

a difference detection unit that detects a difference between a first feature amount input from the first feature amount extraction unit and a second feature amount input from the second feature amount extraction unit.

(2)

The information processing device according to (1), wherein

the first feature amount extraction unit is input with image data captured by a camera,

the second feature amount extraction unit is input with the reference data, the reference data including an image of an object for which image recognition is required, and

the difference detection unit outputs a result of the image recognition in accordance with the difference.

(3)

The information processing device according to (2), comprising:

a storage unit that stores a plurality of the parameters different for each of types of the object for which the image recognition is required, and a plurality of the reference data different for each of the types of the object; and

a selection unit that selects the parameters to be applied to the first feature amount extraction unit and the second feature amount extraction unit, and the reference data to be input to the second feature amount extraction unit, in accordance with the type of the object for which the image recognition is required.

(4)

The information processing device according to any one of (1) to (3), wherein the first feature amount extraction unit and the second feature amount extraction unit include machine learning models having a same structure.

(5)

The information processing device according to any one of (1) to (4), wherein the first processing unit is constituted by hardware, and

the second processing unit is constituted by software.

(6)

An information processing method executed by a computer, the method comprising:

a first processing step including:

a first feature amount extraction step of executing, on data input from a sensor, feature amount extraction processing of extracting a feature amount of the data on the basis of a parameter learned through machine learning, and

a second feature amount extraction step of executing, on reference data, feature amount extraction processing of extracting a feature amount of the reference data on the basis of the parameter; and

a second processing step including:

a difference detection step of detecting a difference between a first feature amount extracted in the first feature amount extraction step and a second feature amount extracted in the second feature amount extraction step.

(7)

An information processing program that causes a computer to execute:

a first processing sequence including:

a first feature amount extraction sequence of executing, on data input from a sensor, feature amount extraction processing of extracting a feature amount of the data on the basis of a parameter learned through machine learning, and

a second feature amount extraction sequence of executing, on reference data, feature amount extraction processing of extracting a feature amount of the reference data on the basis of the parameter;

and

a second processing sequence including:

a difference detection sequence of detecting a difference between a first feature amount extracted in the first feature amount extraction sequence and a second feature amount extracted in the second feature amount extraction sequence.

(8)

An information processing system comprising:

a camera;

an information processing device that performs recognition processing on image data input from the camera; and

a recognition result utilization device that performs predetermined control using a result of the recognition processing, wherein

the information processing device includes:

a first processing unit including:

a first feature amount extraction unit that executes, on the image data, feature amount extraction processing of extracting a feature amount of the image data on the basis of a parameter learned through machine learning, and

a second feature amount extraction unit that executes, on reference data, feature amount extraction processing of extracting a feature amount of the reference data on the basis of the parameter; and

a second processing unit including:

a difference detection unit that detects a difference between a first feature amount input from the first feature amount extraction unit and a second feature amount input from the second feature amount extraction unit.

### REFERENCE SIGNS LIST

1 Information processing device
2 First processing unit
21 FPGA
22 First feature amount extraction unit
23 Second feature amount extraction unit
3 Second processing unit
31 CPU
32 Selection unit
33 Difference detection unit
4 Storage unit
5 Reference data storage part
51 Vehicle image reference data
52 Motorcycle image reference data
6 Parameter storage part
61 Vehicle recognition parameter
62 Motorcycle recognition parameter
100 Information processing system
101 Camera
102 Recognition result utilization device

1. An information processing device comprising:
a first processing unit including:
a first feature amount extraction unit that executes, on data input from a sensor, feature amount extraction processing of extracting a feature amount of the data on the basis of a parameter learned through machine learning, and
a second feature amount extraction unit that executes, on reference data, feature amount extraction processing of extracting a feature amount of the reference data on the basis of the parameter; and
a second processing unit including:
a difference detection unit that detects a difference between a first feature amount input from the first feature amount extraction unit and a second feature amount input from the second feature amount extraction unit.

2. The information processing device according to claim 1, wherein
the first feature amount extraction unit is input with image data captured by a camera,
the second feature amount extraction unit is input with the reference data, the reference data including an image of an object for which image recognition is required, and
the difference detection unit outputs a result of the image recognition in accordance with the difference.

3. The information processing device according to claim 2, comprising:
a storage unit that stores a plurality of the parameters different for each of types of the object for which the image recognition is required, and a plurality of the reference data different for each of the types of the object; and
a selection unit that selects the parameters to be applied to the first feature amount extraction unit and the second feature amount extraction unit, and the reference data to be input to the second feature amount extraction unit, in accordance with the type of the object for which the image recognition is required.

4. The information processing device according to claim 1, wherein the first feature amount extraction unit and the second feature amount extraction unit include machine learning models having a same structure.

5. The information processing device according to claim 1, wherein
the first processing unit is constituted by hardware, and
the second processing unit is constituted by software.

6. An information processing method executed by a computer, the method comprising:
a first processing step including:
a first feature amount extraction step of executing, on data input from a sensor, feature amount extraction processing of extracting a feature amount of the data on the basis of a parameter learned through machine learning, and
a second feature amount extraction step of executing, on reference data, feature amount extraction processing of extracting a feature amount of the reference data on the basis of the parameter; and
a second processing step including:
a difference detection step of detecting a difference between a first feature amount extracted in the first feature amount extraction step and a second feature amount extracted in the second feature amount extraction step.

7. An information processing program that causes a computer to execute:
a first processing sequence including:
a first feature amount extraction sequence of executing, on data input from a sensor, feature amount extraction processing of extracting a feature amount of the data on the basis of a parameter learned through machine learning, and
a second feature amount extraction sequence of executing, on reference data, feature amount extraction processing of extracting a feature amount of the reference data on the basis of the parameter; and
a second processing sequence including:
a difference detection sequence of detecting a difference between a first feature amount extracted in the first feature amount extraction sequence and a second feature amount extracted in the second feature amount extraction sequence.

8. An information processing system comprising:
a camera;
an information processing device that performs recognition processing on image data input from the camera; and
a recognition result utilization device that performs predetermined control using a result of the recognition processing, wherein
the information processing device includes:
a first processing unit including:
a first feature amount extraction unit that executes, on the image data, feature amount extraction processing of extracting a feature amount of the image data on the basis of a parameter learned through machine learning, and
a second feature amount extraction unit that executes, on reference data, feature amount extraction processing of extracting a feature amount of the reference data on the basis of the parameter;
and
a second processing unit including:
a difference detection unit that detects a difference between a first feature amount input from the first feature amount extraction unit and a second feature amount input from the second feature amount extraction unit.
